(19) United States
(12) Patent Application Publication
(10) Pub. No.: US 2026/0266444 A1
(43) Pub. Date: Sep. 10, 2026

(54) WALL-MOUNTED POOL LAMP

(71) Applicant: Shenzhen Maining Innovation Technology Co., Ltd., Shenzhen (CN)

(72) Inventor: Huifeng HUANG, Shenzhen (CN)

(73) Assignee: Shenzhen Maining Innovation Technology Co., Ltd., Shenzhen (CN)

(21) Appl. No.: 19/663,777

(22) Filed: Apr. 30, 2026

Related U.S. Application Data
(63) Continuation-in-part of application No. 19/313,782, filed on Aug. 28, 2025.

(30) Foreign Application Priority Data
Nov. 4, 2024 (CN) 202422679789.X
Dec. 22, 2025 (CN) 202522709469.9

(51) Int. Cl. F21S 9/03; F21V 17/06; F21V 23/00; F21V 31/00; F21W 131/401

(52) U.S. Cl. CPC F21S 9/037; F21V 17/06; F21V 23/006; F21V 31/005; F21W 2131/401

(57) ABSTRACT

A wall-mounted pool lamp includes: a solar module and a lighting module. The lighting module is mounted on the solar module and electrically connected to the solar module. The solar module includes a solar panel, a solar module housing, and a clamping part disposed on the housing, where the solar panel is disposed on a surface of the housing. The wall-mounted pool lamp further includes a clamping component, and the clamping component is detachably disposed on the solar module housing. When the clamping component is connected to the solar module, the clamping component fits the clamping part, to clamp and fasten the wall-mounted pool lamp onto a railing of an above-ground pool. When the clamping component is removed from the solar module, the solar module housing is directly attached to ground surrounding an in-ground pool, and a light-emitting area of the lighting module is extendable into the water.

### CROSS-REFERENCE TO RELATED APPLICATIONS

This application is a continuation-in-part of U.S. Patent Application No. 19/313,782 with a filing date of Aug. 28, 2025, now pending, and further claims priority to Chinese Patent Application No. 202422679789.X with a filing date of Nov. 04, 2024, and this application further claims priority to Chinese Patent Application No. 202522709469.9 with a filing date of Dec. 22, 2025. The content of the aforementioned applications, including any intervening amendments thereto, is incorporated herein by reference.

### TECHNICAL FIELD

The present disclosure belongs to the technical field of swimming pool lighting fixtures, and in particular, to a wall-mounted pool lamp.

### BACKGROUND

Currently, swimming pool lighting devices are generally categorized into two types: recessed luminaires and wall-mounted luminaires. Recessed luminaires are mostly used for in-ground pools, and require reserving a lamp mounting cavity within a pool wall and connecting to a power source through a waterproof junction box during mounting. Wall-mounted luminaires are typically used for above-ground pools or inflatable pools, featuring a simple mounting manner that allows direct fixation to an inner wall of the pool or a bracket without the need for drilling or construction.

However, existing wall-mounted pool lamp structures are mostly designed for a single type of pool. For example, for above-ground pools, wall-mounted lamps generally use snap fasteners, suction cups, or hangers for fixation, relying on a lightweight structure and external support for mounting. For in-ground pools, wall-mounted lamps are often fastened using bolts or embedded parts, are required to stably connect to a concrete pool wall or tiled surface, and meet higher waterproof performance requirements.

Due to significant differences between the two types of pools in terms of structural form, wall thickness, mounting manner, and electrical safety requirements, existing wall-mounted lamps are often unable to be universal for both above-ground and in-ground pools. When a user owns both an above-ground and an in-ground pool, different models of lamps need to be purchased separately, which not only increases equipment costs, but also causes inconvenience in mounting and maintenance.

In addition, some manufacturers attempt to achieve universal mounting by adding adapters or adjusting a fastening structure. However, due to the lack of standardized design, such solutions typically have problems such as poor mounting stability, insufficient waterproof performance, or complex structures, and it is still difficult to meet the user's actual needs for replaceable mounting across a plurality of scenarios.

### SUMMARY OF PRESENT INVENTION

An objective of this application is to provide a wall-mounted pool lamp, which, through structural optimization, is compatible with wall-mounted mounting for both above-ground pools and in-ground pools, thereby resolving a problem in the conventional technology that wall-mounted lamps are difficult to be used universally for above-ground and in-ground pools.

To achieve the purpose, the technical solution adopted in this application is: a wall-mounted pool lamp including a solar module and a lighting module, and the lighting module is electrically connected to the solar module and powered by the solar module.

The solar module includes a solar panel and a solar module housing; the solar panel is arranged on the solar module housing; a clamping part is disposed on the solar module housing; and a sliding slot is defined on a side of the solar module housing facing away from the solar panel.

The wall-mounted pool lamp further includes a clamping component the clamping component comprises a mounting plate, a clamping member, a slider, and a first elastic member; the mounting plate is in a detachable and slip connection with the sliding slot; the mounting plate is provided with a mounting groove, and the slider is slidably connected in the mounting groove; the clamping member is connected to the slider, and the first elastic member is connected between the mounting plate and the slider.

When the mounting plate is connected to the solar module housing, the slider is capable of being pulled to make the first elastic member to generate an elastic force, and hence the clamping member and the clamping part are clamped onto a railing of an above-ground pool.

When the mounting plate is removed from the solar module housing, the solar module housing is attached to ground surrounding an in-ground pool during using.

Further, an operating part and a snap fastener located on the operating part are arranged on a side of the mounting plate facing the sliding slot, and a snap-fitting groove that fits the snap fastener is provided in the sliding slot. When the mounting plate slides to a predetermined position, the snap fastener is snapped into the snap-fitting groove to fasten the mounting plate; and when the operating part is pressed to disengage the snap fastener from the snap-fitting groove, the mounting plate is removable from the pool lamp.

Further, the clamping member is internally provided with an accommodation groove, and the slider includes a first slider section and a second slider section that are connected perpendicularly to each other. The first slider section is slidably connected to the second mounting groove, and the second slider section extends into the accommodation groove and is slidably connected relative to the accommodation groove.

A second elastic member is further disposed in the accommodation groove, where one end of the second elastic member is connected to the clamping member, and another end of the second elastic member is connected to the second slider section.

The clamping member is provided with a clamping plate, and the clamping plate fits the first slider section, so as to clamp the railing in a vertical direction.

Further, the lighting module includes a lighting module housing and an electronic component, where the electronic component is disposed in the lighting module housing, and the lighting module housing is detachably connected to the solar module housing.

Further, the lighting module housing includes a bottom housing, a sealing housing, and a decorative housing. The sealing housing is disposed between the bottom housing and the decorative housing, and the decorative housing is snapped onto the bottom housing; and a first end of the sealing housing is open, and is internally provided with an accommodation space, and the electronic component is disposed in the accommodation space.

Further, the electronic component includes a main control board, a battery, a lamp bead board, and a mounting base. The main control board, the battery, and the lamp bead board are sequentially disposed on the mounting base. The main control board is electrically connected to the battery, and the lamp bead board is electrically connected to the main control board; and the lamp bead board is arranged obliquely downward, and a portion of the decorative housing corresponding to the lamp bead board is provided with a through hole for light to pass through.

Further, pressing members are disposed on both sides of an upper part of the decorative housing for a snap-fit connection with the solar module housing, and third elastic members capable of providing an elastic force for the pressing members are disposed on inner sides of the pressing members.

Further, the solar module housing includes a first housing and a second housing, and the first housing is snapped onto the second housing. The solar panel is disposed on a surface of the first housing, the clamping part is disposed on the second housing, and the clamping part is provided with mounting holes fitting the pressing members.

The beneficial effects of the present disclosure are: 1. Through the innovative design of the detachable clamping component, the same wall-mounted pool lamp can be quickly and easily adapted to two completely different usage scenarios: above-ground pools (with railings) and in-ground pools (without railings). Users do not need to purchase two types of dedicated lamps, greatly improving the product's versatility and market adaptability, and reducing user procurement and management costs.

2. The clamping component is connected to the main body through the sliding slot and the snap fastener structure, enabling quick mounting and locking with a "slide and snap" action, and removal is also very simple by just pressing to release the snap fastener. In addition, through screw rod-driven or elastically self-adaptive clamping manners, the clamping component can be firmly clamped onto pool railings of different thicknesses and shapes, ensuring mounting stability and reliability.

3. The lighting module adopts the lamp bead board that is downwardly inclined. This design facilitates diffusion of light from the lamp bead board, when located below a water surface of a pool, to different areas within the water, thereby increasing an illuminated area at a water surface and a bottom of the pool. In addition, the inclined light does not directly shine into eyes of swimmers in the water.

### BRIEF DESCRIPTION OF THE DRAWINGS

FIG. 1 is a schematic diagram showing an overall structure of a wall-mounted pool lamp according to Embodiment 1 of this application;

FIG. 2 is a structural exploded view showing a wall-mounted pool lamp according to Embodiment 1 of this application;

FIG. 3 is a structural exploded view showing a solar module according to Embodiment 1 of this application;

FIG. 4 is a structural exploded view showing a solar module and a clamping component according to Embodiment 1 of this application;

FIG. 5 is a partial enlarged view of a position A shown in FIG. 4;

FIG. 6 is a structural exploded view showing a clamping component according to Embodiment 1 of this application;

FIG. 7 is a structural exploded view showing a lighting module according to Embodiment 1 of this application;

FIG. 8 is a structural exploded view showing an electronic component and a sealing housing according to Embodiment 1 of this application;

FIG. 9 is a structural exploded view showing a decorative housing according to Embodiment 1 of this application;

FIG. 10 is a partial enlarged view of a position B shown in FIG. 9;

FIG. 11 is a schematic diagram showing a wall-mounted pool lamp connected to a railing according to Embodiment 1 of this application;

FIG. 12 is a structural exploded view showing a clamping component according to Embodiment 2 of this application;

FIG. 13 is a structural exploded view showing a clamping member and a slider according to Embodiment 2 of this application;

FIG. 14 is a schematic diagram showing a wall-mounted pool lamp connected to a railing according to Embodiment 2 of this application; and

FIG. 15 is a schematic diagram showing a wall-mounted pool lamp connected to an in-ground pool for use according to Embodiment 1 or Embodiment 2 of this application.

Reference numerals: 100, wall-mounted pool lamp; 200, railing;

1, solar module; 11, solar panel; 12, first housing; 13, second housing; 131, clamping part; 1311, mounting hole; 132, sliding slot; 133, snap-fitting groove;

2, lighting module; 21, bottom housing; 22, sealing housing; 221, accommodation space; 23, decorative housing; 231, baffle; 232, through hole; 24, electronic component; 241, main control board; 242, battery; 243, lamp bead board; 244, mounting base; 25, third elastic member; 26, pressing member;

3a, first mounting plate; 3a1, first mounting groove; 31, snap fastener; 32, operating part;

3b, second mounting plate; 3b1, second mounting groove;

4, clamping member; 41, accommodation groove; 42, clamping plate;

5, knob; 6, screw rod;

7, slider; 71, first slider section; 72, second slider section; and

8, first elastic member; 9, second elastic member.

### DETAILED DESCRIPTION OF THE EMBODIMENTS

This application is further described in detail below with reference to the drawings and embodiments, but this application is not limited thereto.

Embodiment 1

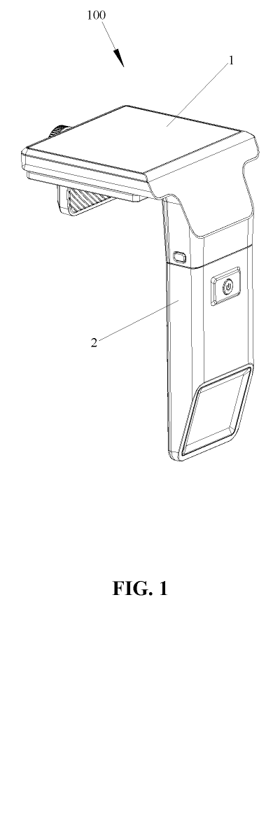

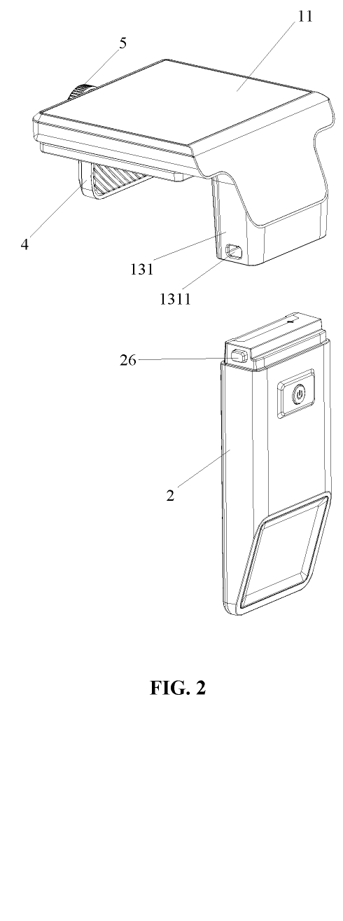

As shown in FIG. 1 and FIG. 2, a wall-mounted pool lamp 100 provided in this embodiment includes a solar module 1 and a lighting module 2, where the lighting module 2 is electrically connected to the solar module 1 and powered by the solar module 1.

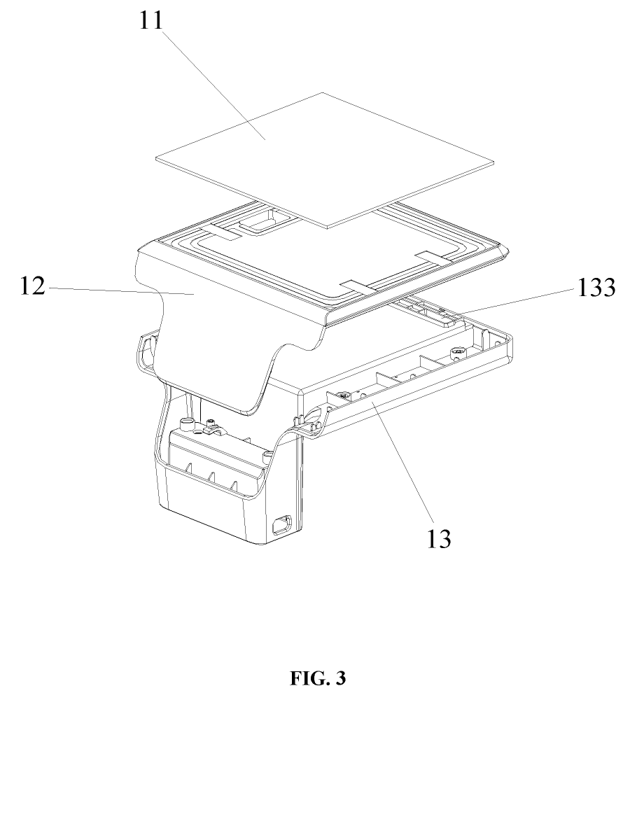

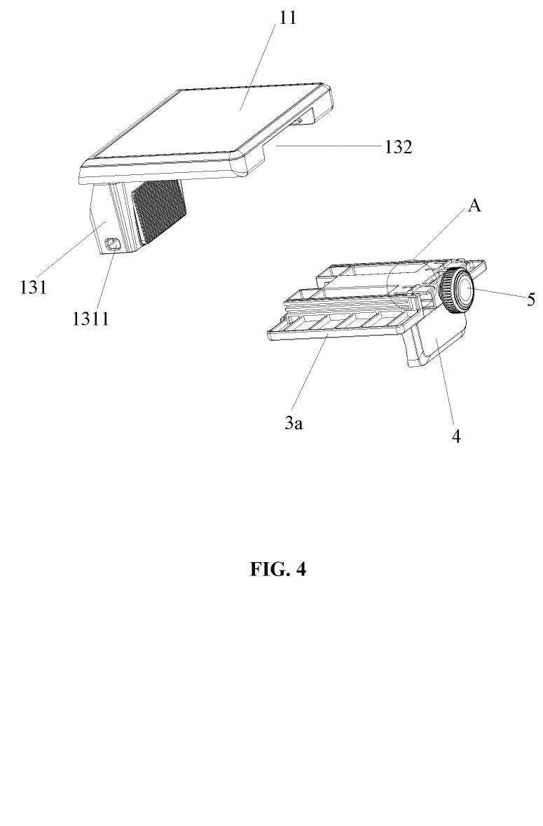

As shown in FIG. 3 and FIG. 4, the solar module 1 includes a solar panel 11 and a solar module housing. The solar module housing includes a first housing 12 and a second housing 13. The solar panel 11 is disposed on a surface of the first housing 12. The first housing 12 and the second housing 13 are snap-fitted together. A clamping part 131 is disposed at a lower end of the second housing 13. A lower end of the clamping part 131 is configured to be detachably connected to the lighting module 2.

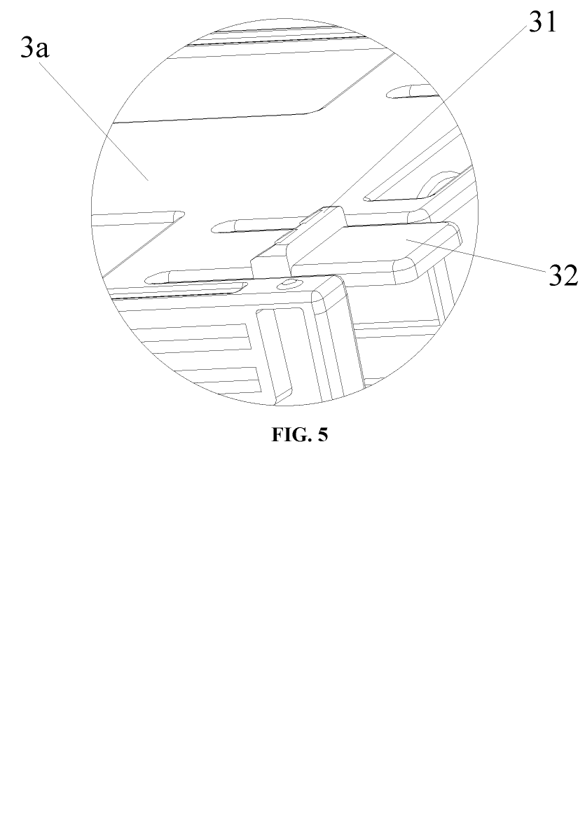

In addition, the second housing 13 is also provided with a sliding slot 132. A clamping component is slidably disposed in the sliding slot 132. Specifically, the clamping component includes a first mounting plate 3a. The first mounting plate 3a is slidable along the sliding slot 132 and is removable from the sliding slot 132. As shown in FIG. 5, the first mounting plate 3a is provided with an operating part 32. The operating part 32 is provided with a snap fastener 31. The second housing 13 is provided with a snap-fitting groove 133 that fits the snap fastener 31. After the clamping component slides into place via the first mounting plate 3a along the sliding slot 132, the snap fastener 31 is snapped into the snap-fitting groove 133 to fasten the first mounting plate 3a. When the clamping component needs to be removed, only the operating part 32 needs to be pressed to drive the snap fastener 31 to disengage from the snap-fitting groove 133, allowing the first mounting plate 3a to slide out from the sliding slot 132.

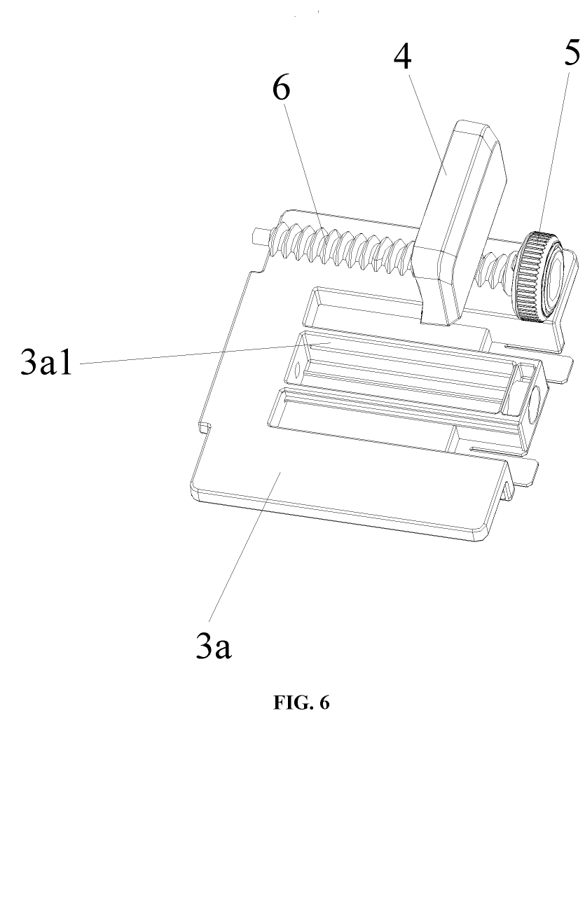

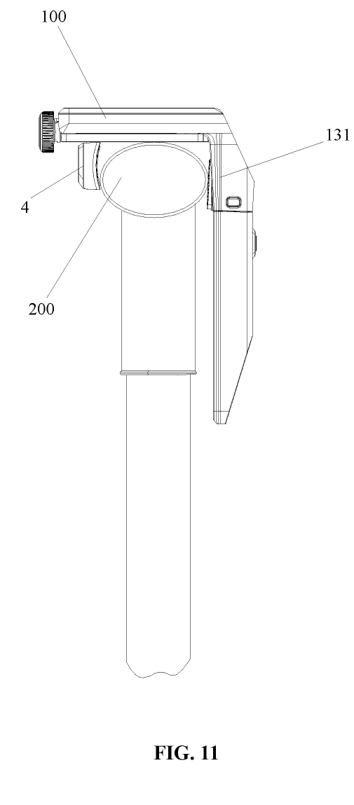

As shown in FIG. 6, the clamping component in this embodiment further includes a clamping member 4, a knob 5, and a screw rod 6. The clamping member 4 is threadedly connected to the screw rod 6. The screw rod 6 is rotatably mounted on the first mounting plate 3a, and one end of the screw rod 6 is fixedly connected to the knob 5. In addition, the first mounting plate 3a is provided with a first mounting groove 3a1 configured to mount the screw rod 6. An upper end of the clamping member 4 is threadedly connected to the screw rod 6 and is located in the first mounting groove 3a1. By rotating the knob 5 to drive the screw rod 6 to rotate, the clamping member 4 is slidable along the first mounting groove 3a1. The clamping member 4 is moved along the screw rod 6 and the first mounting groove 3a1, enabling the clamping member 4 to fit the clamping part 131 to clamp the railing 200 of an above-ground pool (as shown in FIG. 11), and to adapt to railings 200 of different sizes.

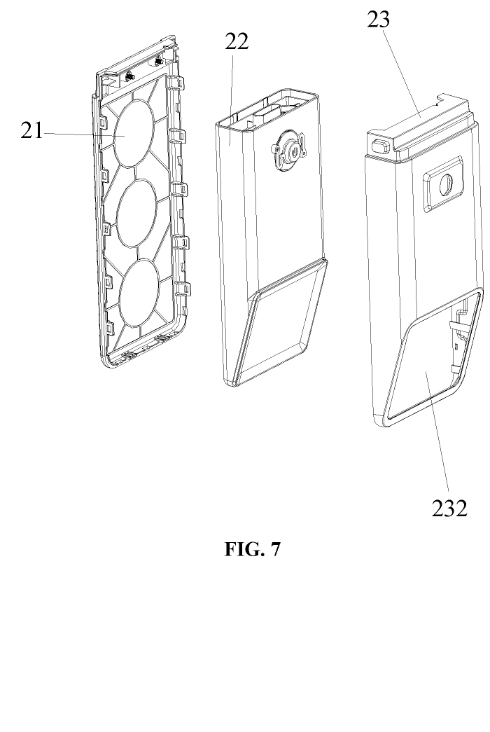

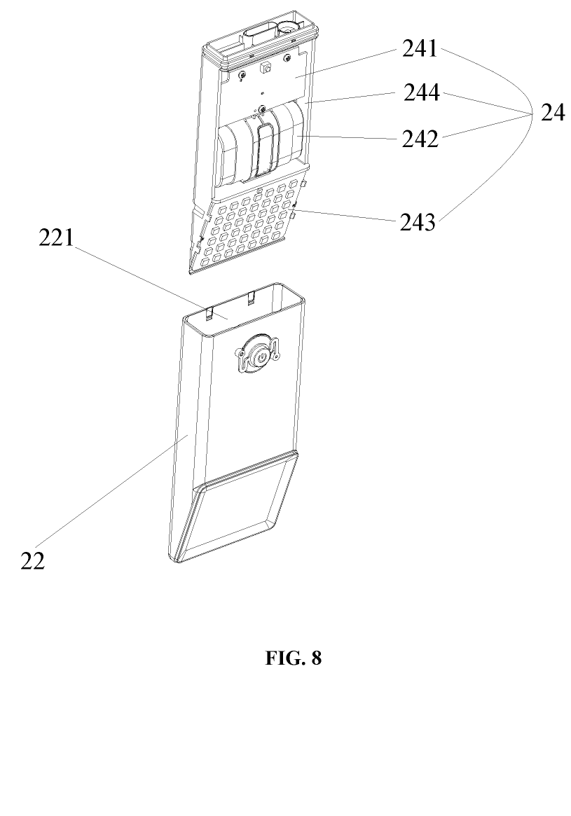

As shown in FIG. 7 to FIG. 9, the lighting module 2 includes a lighting module housing and an electronic component 24. The lighting module housing includes a bottom housing 21, a sealing housing 22, and a decorative housing 23. The decorative housing 23 is snapped onto the bottom housing 21, and the sealing housing 22 is clamped between the decorative housing 23 and the bottom housing 21. A first end of the sealing housing 22 is open and is internally provided with an accommodation space 221. The electronic component 24 is disposed in the accommodation space 221. The electronic component 24 includes a main control board 241, a battery 242, a lamp bead board 243, and a mounting base 244. The main control board 241, the battery 242, and the lamp bead board 243 are disposed on the mounting base 244. The main control board 241 is electrically connected to the battery 242 through a wire (not shown in the figure), and the lamp bead board 243 is electrically connected to the main control board 241 through a wire (not shown in the figure). Under suitable sunlight conditions, solar energy is converted by the solar panel 11 into electrical energy, forming a current loop through wires and the main control board 241, to store the electrical energy in the battery 242, and light up the lamp bead board 243 when light and time conditions are met or when manually activated. In other implementations, the main control board 241 is electrically connected to the solar panel 11 through spring wires or metal contacts.

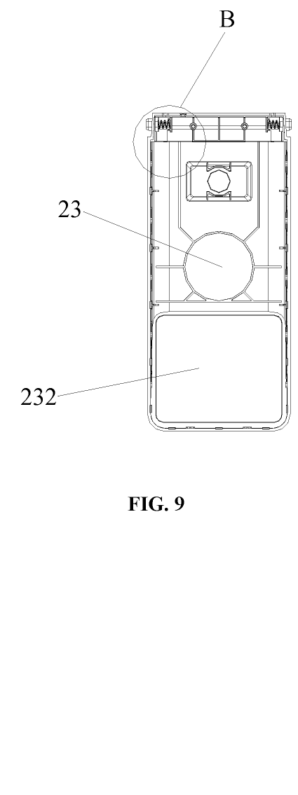

Further, the sealing housing 22 may be completely transparent, or a portion of the sealing housing 22 corresponding to the lamp bead board 243 is made transparent to allow light to pass through. Correspondingly, as shown in FIG. 9, a portion that is of the decorative housing 23 and that corresponds to the lamp bead board 243 is provided with a through hole 232, to allow light to pass through.

Further, the lamp bead board 243 is arranged obliquely downward, to facilitate diffusion of light from the lamp bead board 243, when located below a water surface of a pool, to different areas in the water, thereby increasing the illuminated area at the water surface and bottom of the pool. In addition, the inclined light does not directly shine into eyes of swimmers in the water.

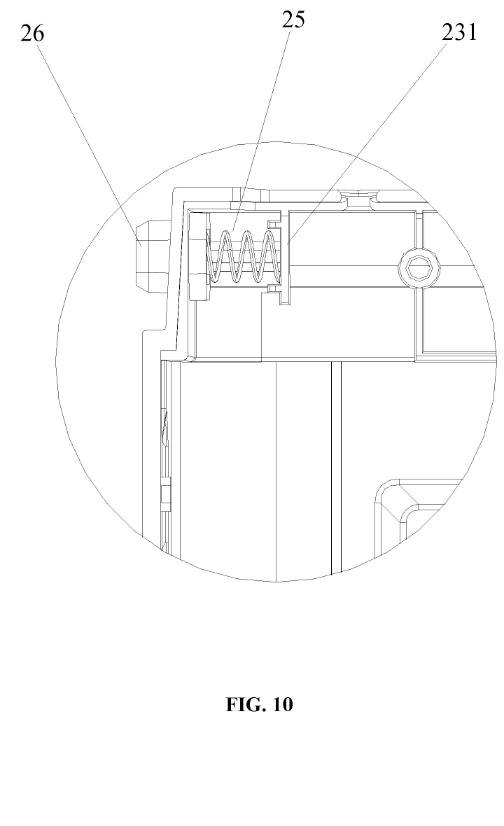

In addition, as shown in FIG. 9 and FIG. 10, the lighting module 2 further includes pressing members 26 and third elastic members 25. The pressing members 26 are disposed on left and right sides of an upper end of the decorative housing 23. Baffles 231 that fit the third elastic members 25 are disposed on the decorative housing 23. The third elastic members 25 abut between the baffles 231 and the pressing members 26. Furthermore, mounting holes 1311 that fit the pressing members 26 are provided on the clamping part 131. The pressing members 26 are snapped into the mounting holes 1311 and are not easily loosened due to an action force of the third elastic members 25. The third elastic members 25 may be springs or rubber blocks.

When the wall-mounted pool lamp 100 is used in an above-ground pool, the clamping member 4 of the clamping component fits the clamping part 131 to clamp onto the railing 200 of the above-ground pool, as shown in FIG. 11.

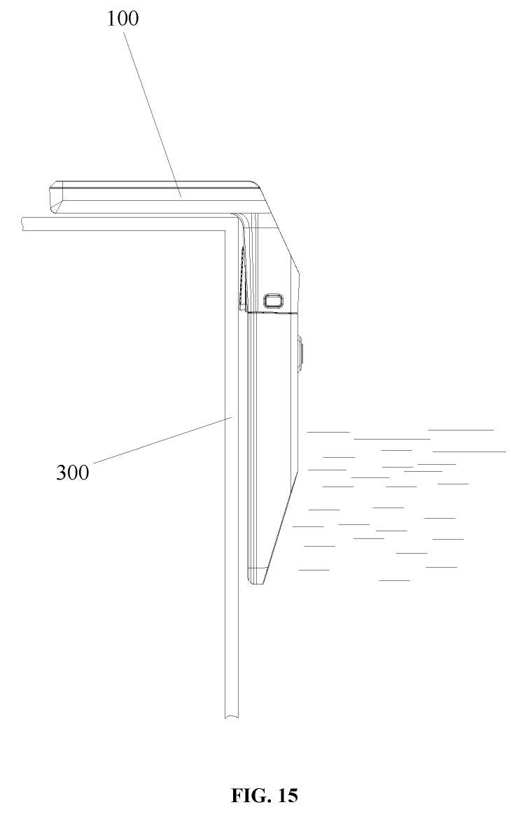

As shown in FIG. 15, when the wall-mounted pool lamp 100 needs to be used in an in-ground pool, the clamping component is removed, and the second housing 13 of the solar module 1 is attached to the ground surrounding the pool. In addition, a lower part of the lighting module 2 extends into the water, enabling the lamp bead board to be below the water surface to provide illumination. In this way, the wall-mounted pool lamp 100 can be quickly and easily adapted for use between above-ground and in-ground pools.

Embodiment 2

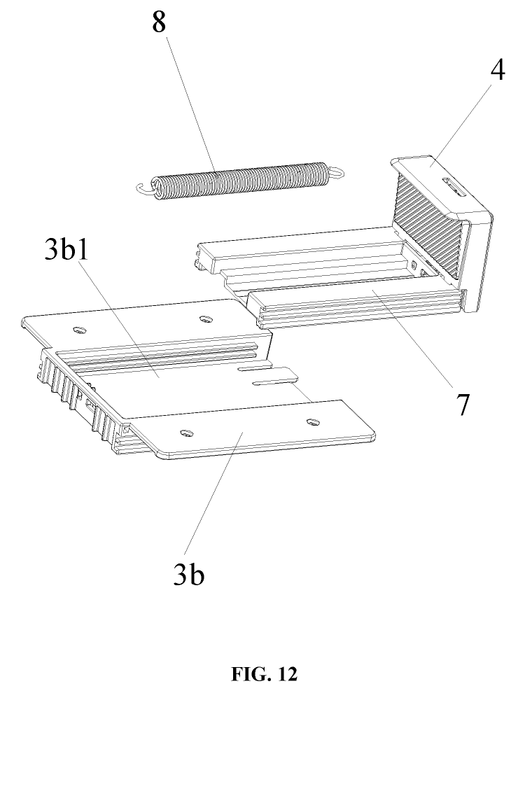

A difference between this embodiment and Embodiment 1 lies in the structure of the clamping component. As shown in FIG. 12, the clamping component includes a second mounting plate 3b, a clamping member 4, a slider 7, and a first elastic member 8. The second mounting plate 3b is configured to be in a sliding connection to the sliding slot 132 in the second housing 13 and is snap-fitted and locked by the snap fastener 31 and the snap-fitting groove 133 in the second housing 13. During unlocking, the operating part 32 is pressed to disengage the snap fastener 31 from the snap-fitting groove 133. The second mounting plate 3b is provided with a second mounting groove 3b1. The slider 7 is slidably connected in the second mounting groove 3b1. The clamping member 4 is connected to an end of the slider 7 facing away from the clamping part 131. The first elastic member 8 is connected between the slider 7 and the second mounting plate 3b. When in use, an operator pulls the clamping member 4, driving the slider 7 to slide along the mounting groove 3b1 to adapt to different specifications of pool railings, and then clamps the pool railing through a restoring force of a spring. Specifically, the first elastic member 8 may be a spring.

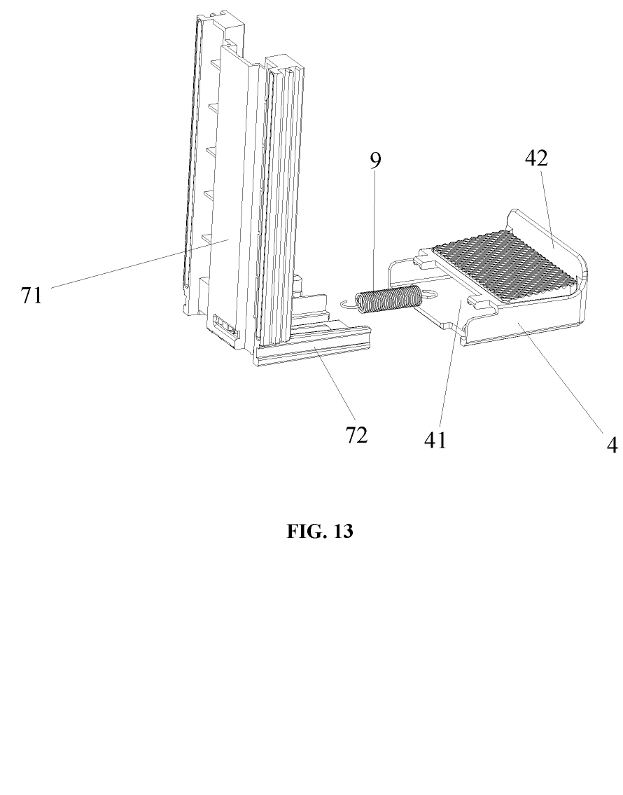

As shown in FIG. 13, the slider 7 is divided into two perpendicularly connected sections: a first slider section 71 and a second slider section 72. The first slider section 71 is slidably connected to the second mounting groove 3b1. The clamping member 4 is internally provided with an accommodation groove 41. The second slider section 72 is located in the accommodation groove 41 and is slidably connected relative to the accommodation groove 41. A second elastic member 9 is further disposed in the accommodation groove 41, one end of the second elastic member 9 is connected to the clamping member 4, and another end of the second elastic member 9 is connected to the second slider section 72. In addition, a clamping plate 42 extends outwardly from an end of the clamping member 4 facing away from the first slider section 71. The clamping member 4 slides along the second slider section 72, and the clamping plate 42 fits the first slider section 71 to clamp the pool railing in a vertical direction.

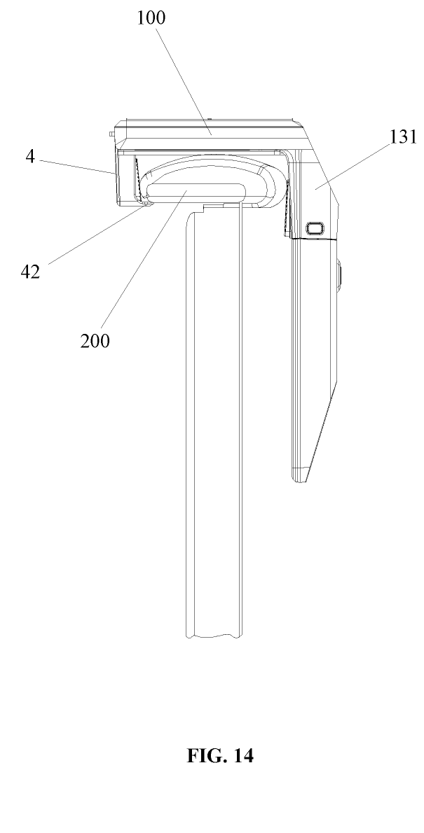

When the wall-mounted pool lamp is used in an above-ground pool, the clamping member 4 of the clamping component fits the clamping part 131 to clamp onto the railing 200 of the above-ground pool. In addition, the clamping plate 42 fits the first slider section 71 to clamp the railing 200 in the vertical direction, as shown in FIG. 14.

When the wall-mounted pool lamp 100 needs to be used in an in-ground pool, the clamping component is removed, and the second housing 13 of the solar module 1 is attached to the ground surrounding the pool. In addition, the lower part of the lighting module 2 extends into the water, enabling the lamp bead board to be below the water surface to provide illumination, as shown in FIG. 15. In this way, the wall-mounted pool lamp 100 can be quickly and easily adapted for use between above-ground and in-ground pools.

The above embodiments are merely intended to describe the technical solutions of this application, rather than to limit this application. It should be understood that, a person of ordinary skill in the art may still make modifications or equivalent substitutions to the specific embodiments of this application without departing from the spirit and scope of this application, and these modifications or equivalent substitutions shall fall within the protection scope of the to-be-approved claims of this application.

What is claimed is:

1. A wall-mounted pool lamp, comprising: a solar module (1) and a lighting module (2), wherein the lighting module (2) is electrically connected to the solar module (1) and powered by the solar module (1);
the solar module (1) comprises a solar panel (11) and a solar module housing; the solar panel (11) is arranged on the solar module housing; a clamping part (131) is further arranged on the solar module housing; a sliding slot (132) is defined on a side of the solar module housing facing away from the solar panel (11);
the wall-mounted pool lamp further comprises a clamping component; the clamping component comprises a mounting plate (3b), a clamping member (4), a slider (7), and a first elastic member (8); the mounting plate (3b) is in a detachable and slip connection with the sliding slot (132); the mounting plate (3b) is provided with a mounting groove (3b1), and the slider (7) is slidably connected in the mounting groove (3b1); the clamping member (4) is connected to the slider (7), and the first elastic member (8) is connected between the mounting plate (3b) and the slider (7);
when the mounting plate (3b) is connected to the solar module housing, the slider (7) is capable of being pulled to make the first elastic member (8) to generate an elastic force, and hence the clamping member (4) and the clamping part (131) are clamped onto a railing (200) of an above-ground pool; and
when the mounting plate (3b) is removed from the solar module housing, the solar module housing is attached to ground surrounding an in-ground pool during using.

2. The wall-mounted pool lamp according to claim 1, wherein the clamping member (4) is internally provided with an accommodation groove (41), and the slider (7) comprises a first slider section (71) and a second slider section (72) that are connected perpendicularly to each other; the first slider section (71) is slidably connected to the mounting groove (3b1), and the second slider section (72) extends into the accommodation groove (41) and is slidably connected relative to the accommodation groove (41).

3. The wall-mounted pool lamp according to claim 2, further comprising a second elastic member (9), wherein the second elastic member (9) is disposed in the accommodation groove (41), one end of the second elastic member (9) is connected to the clamping member (4), and another end of the second elastic member (9) is connected to the second slider section (72).

4. The wall-mounted pool lamp according to claim 2, wherein the clamping member (4) is provided with a clamping plate (42), and the clamping plate (42) fits the first slider section (71), so as to clamp the railing (200) in a vertical direction.

5. The wall-mounted pool lamp according to claim 1, wherein
an operating part (32) is arranged on a side of the mounting plate (3b) facing the sliding slot (132), and snap fastener (31) is arranged on the operating part (32); a snap-fitting groove (133) matching the snap fastener (31) is defined in the sliding slot (132);
when the mounting plate (3b) slides to a preset position along the sliding slot (32), the snap fastener (31) is snapped into the snap-fitting groove (133) to fasten the pool lamp; when the operating part (32) is pressed to drive the snap fastener (31) to disengage from the snap-fitting groove (133), the mounting plate (3b) is allowed to depart from the solar module (1).

6. The wall-mounted pool lamp according to claim 1, wherein the lighting module (2) comprises a lighting module housing and an electronic component (24), the electronic component (24) is arranged in the lighting module housing, and the lighting module housing is detachably connected to the solar module housing.

7. The wall-mounted pool lamp according to claim 6, wherein the lighting module housing comprises a bottom housing (21), a sealing housing (22), and a decorative housing (23); the sealing housing (22) is disposed between the bottom housing (21) and the decorative housing (23), and the decorative housing (23) is snapped onto the bottom housing (21); and a first end of the sealing housing (22) is open and is internally provided with an accommodation space (221), and the electronic component (24) is disposed in the accommodation space (221).

8. The wall-mounted pool lamp according to claim 7, wherein the electronic component (24) comprises a main control board (241), a battery (242), a lamp bead board (243), and a mounting base (244); the main control board (241), the battery (242), and the lamp bead board (243) are sequentially disposed on the mounting base (244); the main control board (241) is electrically connected to the battery (242), and the lamp bead board (243) is electrically connected to the main control board (241); and the lamp bead board (243) is arranged obliquely downward, and a portion that is of the decorative housing (23) and that corresponds to the lamp bead board (243) is provided with a through hole (232) for light to pass through.

9. The wall-mounted pool lamp according to claim 7, wherein pressing members (26) are disposed on both sides of an upper part of the decorative housing (23) and are configured for a snap-fit connection with the solar module housing, and third elastic members (25) capable of providing an elastic force for the pressing members (26) are disposed on inner sides of the pressing members (26).

10. The wall-mounted pool lamp according to claim 9, wherein the solar module housing comprises a first housing (12) and a second housing (13), and the first housing (12) is snapped onto the second housing (13); and
the solar panel (11) is disposed on a surface of the first housing (12), the clamping part (131) is disposed on the second housing (13), and the clamping part (131) is provided with mounting holes (1311) fitting the pressing members (26).
